(19) United States
(12) Patent Application Publication
(10) Pub. No.: US 2018/0035504 A1
(43) Pub. Date: Feb. 1, 2018

(54) SIGNAL TRANSMITTER AND LIGHTING SYSTEM

(71) Applicant: Panasonic Intellectual Property Management Co., Ltd., Osaka (JP)

(72) Inventors: Hirofumi KONISHI, Osaka (JP); Masashi MOTOMURA, Osaka (JP)

(21) Appl. No.: 15/637,449

(22) Filed: Jun. 29, 2017

(30) Foreign Application Priority Data
Jul. 29, 2016 (JP) 2016-150045

(51) Int. Cl. H05B 33/08; H05B 37/02

(52) U.S. Cl. CPC H05B 33/0845; H05B 37/0209; H05B 37/0272; H05B 37/0263; H05B 33/0815; H05B 33/0884

(57) ABSTRACT

A signal transmitter includes a power supply, an external signal receiver and a communication controller. The external signal receiver is configured to receive an external instruction signal that represents a lighting state of the light fixture based on an output of a sensor configured to detect a state of a lighting space illuminated by the light fixture. The communication controller is configured to change an output voltage level of the power supply to transmit, to the light fixture, a transmission signal for setting the light fixture to the lighting state represented by at least the external instruction signal.

### CROSS REFERENCE TO RELATED APPLICATION

This application claims the benefit and priority of Japanese Patent Application No. 2016-150045, filed on Jul. 29, 2016, the entire contents of which is incorporated herein by reference.

### TECHNICAL FIELD

The present disclosure relates to a signal transmitter and a lighting system.

### BACKGROUND ART

Conventionally, an LED lighting system having a dimmer, a power supply and a light source (a light fixture) has been proposed (see JP 2010-287372 A (hereinafter referred to as “Document 1”)).

The power supply of the LED lighting system described in Document 1 includes an AC/DC converter and a dimming interface. The dimming interface is configured to superpose a dimming signal from the dimmer on a DC voltage obtained from the AC/DC converter. The light source includes a current controller and an LED light source. The current controller is configured to receive a voltage (a signal superposed voltage) from the dimming interface to light the LED light source by the signal superposed voltage as a power supply while controlling the light output of the LED light source based on the signal superposed voltage.

In the lighting system described in Document 1, a high frequency dimming signal (a transmission signal) is superposed on the DC voltage through the dimming interface. In this case, there is a possibility that electromagnetic waves may be radiated as noise through the wiring to the light fixture as an antenna or that the dimming signal may leak out as noise (to adjacent houses) through the wiring.

### SUMMARY

It is an object of the present disclosure to provide a signal transmitter and a lighting system, capable of lighting a light fixture by DC power and decrease transmission noise of a transmission signal and leakage of the transmission signal.

A signal transmitter according to an aspect of the present disclosure includes a power supply, an external signal receiver and a communication controller. The power supply is configured to receive DC power to supply a DC output voltage to a light fixture. The external signal receiver is configured to receive an external instruction signal that represents a lighting state of the light fixture based on an output of a sensor configured to detect a state of a lighting space illuminated by the light fixture. The communication controller is configured to control signal transmission to the light fixture by controlling the power supply. The communication controller is configured to change an output voltage level of the power supply to transmit, to the light fixture, a transmission signal for setting the light fixture to the lighting state represented by at least the external instruction signal.

A lighting system includes signal transmitters, one AC/DC converter and light fixture sets. The AC/DC converter is configured to receive AC power to supply DC power to each of the signal transmitters. The light fixture sets are electrically connected to the signal transmitters, respectively. Each of the light fixture sets includes at least a light fixture. Each of the signal transmitters includes a power supply, an external signal receiver and a communication controller. The power supply is configured to receive the DC power to supply a DC output voltage to a corresponding light fixture set. The external signal receiver is configured to receive an external instruction signal that represents a lighting state of the corresponding light fixture set based on an output of a sensor configured to detect a state of a lighting space illuminated by the corresponding light fixture set. The communication controller is configured to control signal transmission to the corresponding light fixture set by controlling the power supply. The communication controller is configured to change an output voltage level of the power supply to transmit, to the corresponding light fixture set, a transmission signal for setting the corresponding light fixture set to the lighting state represented by at least the external instruction signal.

### BRIEF DESCRIPTION OF THE DRAWINGS

The figures depict one or more implementations in accordance with the present teaching, by way of example only, not by way of limitation. In the figures, like reference numerals refer to the same or similar elements where:

FIG. 1 is a block diagram of a lighting system in accordance with an embodiment of the present disclosure;

FIG. 2 is a front view of an operation unit in a signal transmitter of the lighting system;

FIG. 3 is a timing chart illustrating an operation of the signal transmitter;

FIG. 4 is a timing chart illustrating another operation of the signal transmitter;

FIG. 5 is a timing chart illustrating a normal judgement operation and an abnormal judgement operation by the signal transmitter;

FIG. 6 is a waveform chart representing an output current and a dimming rate of the signal transmitter;

FIG. 7 is another waveform chart representing an output current and a dimming rate of the signal transmitter;

FIG. 8 is a correlation diagram of an excess ratio of the output current and a first dimming ratio of the signal transmitter;

FIG. 9 is a correlation diagram of an excess ratio of the output current and a time period of the second dimming ratio of the signal transmitter;

FIG. 10 is a block diagram of a first modified example of the lighting system; and

FIG. 11 is a block diagram of a second modified example of the lighting system.

### DETAILED DESCRIPTION

The following embodiments generally relate to signal transmitters and lighting systems and, more particularly, to a signal transmitter configured to transmit a transmission signal and a lighting system including the signal transmitter, a light fixture and an AC/DC converter.

The signal transmitter and the lighting system in the present embodiment may be mainly applied to an office, a factory, a store or the like. The signal transmitter and the lighting system in the present embodiment may also be applied to a dwelling such as a detached house or a condominium.

The embodiment will be explained with reference to the drawings.

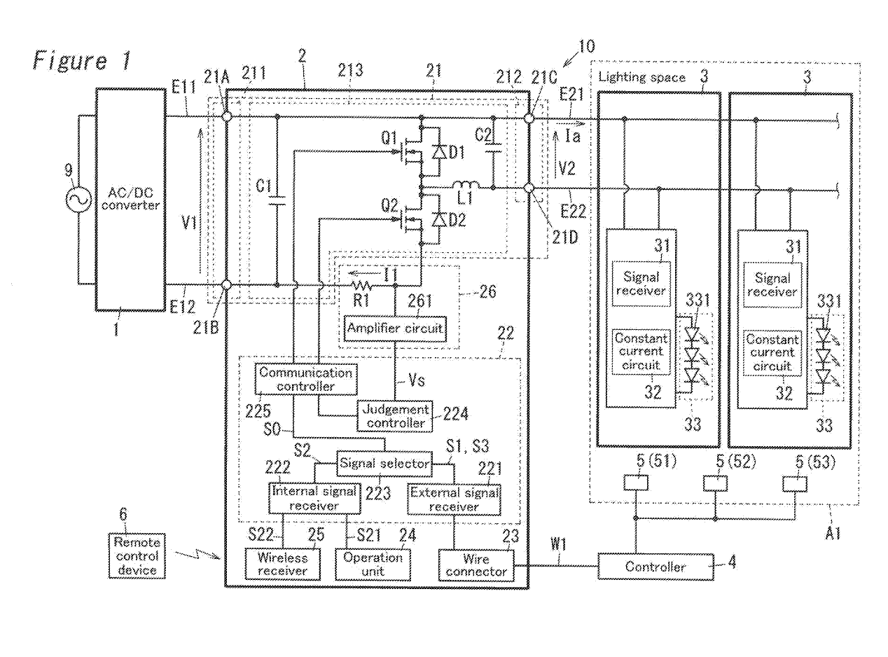

As shown in FIG. 1, a lighting system 10 in the embodiment preferably includes an AC/DC converter 1, a signal transmitter 2 and one or more light fixtures 3.

Preferably, the AC/DC converter 1 is configured to receive commercial power of a commercial power supply 9 to output a DC voltage V1. The AC/DC converter 1 may adjust the DC voltage V1 (a voltage value thereof) to a prescribed value.

Preferably, the signal transmitter 2 is configured to receive the DC voltage V1 via two power supply lines E11 and E12 from the AC/DC converter 1 to output a DC output voltage (hereinafter simply referred to as an “output voltage”) V2 via two power supply lines E21 and E22. Light fixtures 3 may be electrically connected between the two power supply lines E21 and E22. In the embodiment, each light fixture 3 is configured to be activated by the output voltage V2 as a power supply. That is, it is preferable that the power to be supplied to each light fixture 3 via the signal transmitter 2 from the AC/DC converter 1 be DC power and that the power distribution to each light fixture 3 from the AC/DC converter 1 be DC power distribution. Hereinafter, the DC voltage V1 is referred to as an “input voltage V1”.

Preferably, each light fixture 3 is configured to emit light by the DC power supplied via the two power supply lines E21 and E22 to illuminate a space A1 (a lighting space A1) as an lighting object.

Hereinafter, the signal transmitter 2 of the embodiment will be explained. As shown in FIG. 1, the signal transmitter 2 may include a power supply 21, a main controller 22, a wire connector 23, an operation unit (a console) 24, a wireless receiver 25 and a detector 26.

The power supply 21 may include an input unit 211, an output unit 212 and a step-down circuit 213.

Preferably, the input unit 211 is configured to receive the DC input voltage (hereinafter simply referred to as an “input voltage”) V1. The input unit 211 may have a first input terminal 21A and a second input terminal 21B. The second input terminal 21B may be electrically connected to ground (ground of the signal transmitter 2). In this case, the first input terminal 21A is an input terminal on a high potential side, while the second input terminal 21B is an input terminal on a low potential side. Here, “electrically connected” means direct or indirect electrical connection.

Preferably, the input unit 211 is electrically connected to the AC/DC converter 1 via the two power supply lines E11 and E12. In this case, the first input terminal 21A is electrically connected to one end of the power supply line E11, while the second input terminal 21B is electrically connected to one end of the power supply line E12. Respective other ends of the two power supply lines E11 and E12 are electrically connected to the AC/DC converter 1. In the embodiment, the input unit 211 is to receive the input voltage V1 via the two power supply lines E11 and E12. That is, it is preferable that the AC/DC converter 1 be configured to apply the input voltage V1 to the input unit 211.

Preferably, the output unit 212 is configured to output the output voltage V2. The output unit 212 may have a first output terminal 21C and a second output terminal 21D. In the example of FIG. 1, the output unit 212 is electrically connected to each light fixture 3 via the two power supply lines E21 and E22. In this example, the first output terminal 21C is electrically connected to one end of the power supply line E21, while the second output terminal 21D is electrically connected to one end of the power supply line E22. Respective other ends of the two power supply lines E21 and E22 are electrically connected to the light fixtures 3.

Note that each of the input voltage V1 and the output voltage V2 (each voltage value thereof) is preferably 50V or less. In the embodiment, a maximum of each voltage value is 36V.

Preferably, the step-down circuit 213 is configured to controllably adjust the output voltage V2 by stepping down the input voltage V1. As shown in FIG. 1, the step-down circuit 213 may include two capacitors C1 and C2, an inductor L1 and two switches Q1 and Q2. Each of the two switches Q1 and Q2 may be a normally-off MOSFET (Metal Oxide Semiconductor Field Effect Transistor). In the embodiment, the switch Q1 corresponds to a first switch, while the switch Q2 corresponds to a second switch. Accordingly, the switch Q1 and the switch Q2 are hereinafter referred to as a “first switch Q1” and a “second switch Q2”, respectively.

The capacitor C1 may be an input capacitor that is electrically connected in parallel with the input unit 211. That is, the capacitor C1 may be electrically connected between the first and second input terminals 21A and 21B. A terminal, on a high potential side, of the capacitor C1 may be electrically connected to a first end (a drain) of the first switch Q1. A control end (a gate) of the first switch Q1 may be electrically connected to the main controller 22. A second end (a source) of the first switch Q1 may be electrically connected to a first end (a drain) of the switch Q2. A control end (a gate) of the second switch Q2 may be electrically connected to the main controller 22. A second end (a source) of the second switch Q2 may be electrically connected to a terminal, on a low potential side, of the capacitor C1.

In the example of FIG. 1, a first diode D1 is a body diode of the first switch Q1. That is, the first diode D1 is electrically connected in anti-parallel with the first switch Q1. Specifically, a first end (a cathode) of the first diode D1 is electrically connected to a terminal, on a high potential side, of the first switch Q1 (the drain of the first switch Q1), while a second end (an anode) of the first diode D1 is electrically connected to a terminal, on a low potential side, of the first switch Q1 (the source of the first switch Q1).

In the example of FIG. 1, a second diode D2 is a body diode of the second switch Q2. That is, the second diode D2 is electrically connected in anti-parallel with the second switch Q2. Specifically, a first end (a cathode) of the second diode D2 is electrically connected to a terminal, on a high potential side, of the second switch Q2 (the drain of the second switch Q2), while a second end (an anode) of the second diode D2 is electrically connected to a terminal, on a low potential side, of the second switch Q2 (the source of the second switch Q2).

In the example, the drain of the first switch Q1 is electrically connected to a terminal, on a high potential side, of the capacitor C2. A terminal, on a low potential side, of the capacitor C2 is electrically connected to the source of the first switch Q1 via the inductor L1. That is, one end of the inductor L1 is electrically connected to the source of the first switch Q1, while another end of the inductor L1 is electrically connected to the terminal, on the low potential side, of the capacitor C2.

The capacitor C2 may be a smoothing capacitor that is provided between the output terminals, and electrically connected in parallel with the output unit 212. That is, the capacitor C2 may be electrically connected between the first and second output terminals 21C and 21D.

Preferably, the main controller 22 includes an external signal receiver 221, an internal signal receiver 222, a signal selector 223, a judgement controller 224 and a communication controller 225. The main controller 22 may further have a function for controlling an operation of the power supply 21.

In the embodiment, the external signal receiver 221 is electrically connected to the wire connector 23. For example, a communication cable W1 is connected to the wire connector 23, and allows a signal from a controller (an external controller) 4 to pass through. The communication cable W1 may be any of a twisted pair cable, an exclusive communication cable or a LAN (Local Area Network) cable, but is not limited to thereto. In this case, the external signal receiver 221 is configured to receive a signal from the controller 4 via the wire connector 23.

Preferably, one or more sensors 5 (e.g., sensors 51-53) is provided in or around the lighting space A1, and the controller 4 is configured to receive a detection signal from the sensor(s) 5. Each sensor 5 may be activated by the output voltage V2 between the two power supply lines E21 and E22, like the light fixtures 3. In the example of FIG. 1, sensors 5 such as an illuminance sensor 51, a motion sensor 52 and a fire sensor 53 are provided. The illuminance sensor 51 may have a function that detects illuminance in the lighting space A1. The motion sensor 52 may have a function that detects human presence in the lighting space A1. The fire sensor 53 may detect, by heat, smoke or the like, the occurrence of fire in or around the lighting space A1. Note that the communication between the controller 4 and the sensors 5 may be any of wire communication and wireless communication. The object to be detected by each sensor 5 is not limited to a particular event.

Preferably, the controller 4 is configured to generate an external instruction signal (S1, described later) that represents a lighting state of each light fixture 3 based on the detection signals of the sensors 5. The controller 4 may transmit the external instruction signal S1 to the signal transmitter 2 via the communication cable W1. Preferably, the external signal receiver 221 is configured to receive the external instruction signal 51 from the controller 4 via the wire connector 23.

The internal signal receiver 222 may be electrically connected to the operation unit 24 and the wireless receiver 25.

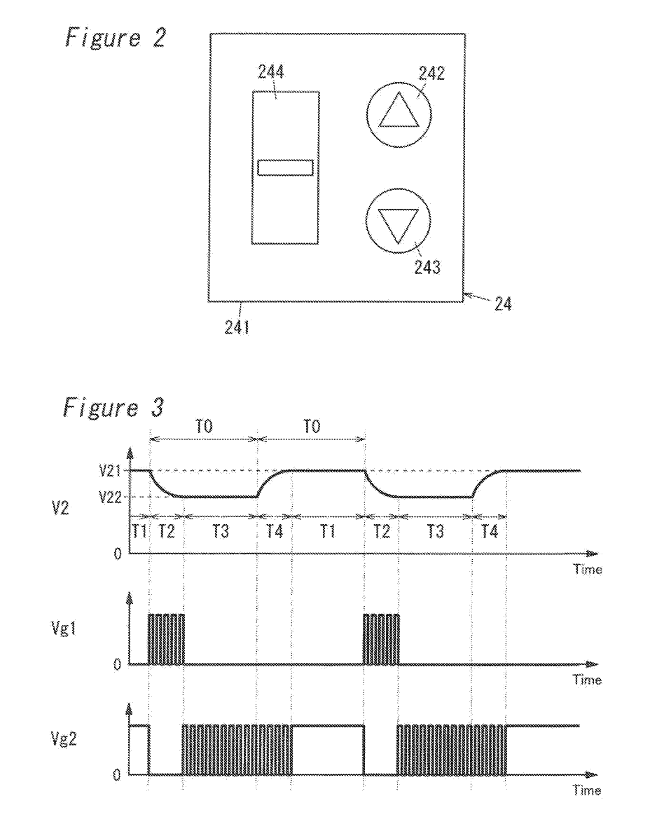

FIG. 2 depicts a configuration example of the operation unit 24. In this example, the operation unit 24 has buttons 242 and 243 and a display 244 that are arranged on a front surface of a housing 241 shaped like a rectangular case. The button 242 may be pushed by a user in order to increase each dimming rate of the light fixtures 3. The button 243 may be pushed by the user in order to decrease each dimming rate of the light fixtures 3. The display 244 may be composed of a level meter that displays the dimming rate by, for example the numbers of bars in order to visually display the dimming rate that is set with the buttons 242 and 243. The operation unit 24 may be any of; a configuration in which the light fixtures 3 are provided with their own operation units 24, or one each; and a configuration in which the light fixtures 3 share an operation unit 24. In the case of sharing an operation unit 24, the operation unit 24 may further include a button for selecting a light fixture 3 as a setting target of the dimming rate from the light fixtures 3.

Preferably, the operation unit 24 is configured to generate an internal instruction signal S21 that represents a lighting state of each light fixture 3 according to the operations of the buttons 242 and 243, and then supply the internal instruction signal S21 to the internal signal receiver 222. Preferably, the internal signal receiver 222 is configured to receive the internal instruction signal S21 from the operation unit 24.

The wireless receiver 25 may be configured to receive a wireless signal from a remote control device 6 to be operated by a user in the lighting space A1. Examples of the wireless signal from the remote control device 6 include radio wave, near infrared light, visible light and the like. The remote control device 6 may include buttons and a display like the operation unit 24 and be configured to generate an internal instruction signal S22, which represents a lighting state of each light fixture 3, based on according to user's operation. The remote control device 6 may be configured to wirelessly transmit the internal instruction signal S22 to the wireless receiver 25. Preferably, the wireless receiver 25 is configured to receive the internal instruction signal S22 from the remote control device 6 to supply the internal instruction signal S22 to the internal signal receiver 222. In this case, the internal signal receiver 222 is configured to receive the internal instruction signal S22 from the wireless receiver 25.

Hereinafter, an internal instruction signal S2 will be used when the internal instruction signals S21 and S22 are not distinguished from each other.

Preferably, the signal selector 223 is configured to receive the external instruction signal S1 from the external signal receiver 221 and the internal instruction signal S2 from the internal signal receiver 222 to select any one instruction signal from the external and internal instruction signals S1 and S2.

The signal selector 223 is further configured to output, as an instruction signal S0, the instruction signal that is selected from the external and internal instruction signals S1 and S2.

In this case, the instruction signal S0 is to be supplied from the signal selector 223 to the communication controller 225. Receiving the instruction signal S0, the communication controller 225 can recognize a lighting state of a light fixture(s) 3 instructed by the instruction signal S0. The communication controller 225 is therefore configured to control the step-down circuit 213 based on the instruction signal S0 to change the output voltage V2, specifically an output voltage level of the power supply 21, thereby transmitting a transmission signal, for controlling the light fixtures 3, to the light fixtures 3.

Each light fixture 3 may include a signal receiver 31, a constant current circuit 32 and a light source 33.

Preferably, the signal receiver 31 is configured to monitor the output voltage V2 between the two power supply lines E21 and E22 to demodulate the transmission signal by comparing the output voltage V2 with a threshold. That is, the signal receiver 31 may detect a change in the output voltage level to acquire the transmission signal. The signal receiver 31 may be configured to supply the constant current circuit 32 with a PWM (Pulse Width Modulation) signal based on the transmission signal. The signal receiver 31 is, for example a control IC (Integrated Circuit). The control IC preferably includes a buffer memory.

For example, the signal receiver 31 is configured to: judge that a data element of the transmission signal is “0” when the output voltage V2 is greater than or equal to the threshold; and judge that the data element of the transmission signal is “1” when the output voltage V2 is less than the threshold. Preferably, the signal receiver 31 is configured to recognize the instructed lighting state based on the data of the demodulated transmission signal to control the constant current circuit 32 so that the light source 33 is adjusted to the instructed lighting state.

The embodiment controls the dimming rate as the lighting state of the light source 33. In this case, the signal receiver 31 is configured to recognize the instructed dimming rate based on the data of the demodulated transmission signal to supply the constant current circuit 32 with a PWM signal that is set to a duty corresponding to the instructed dimming rate. For example, the signal receiver 31 may: set the duty to 100% when the dimming rate (a dimming ratio) is 100 [%]; set the duty to 0% when the dimming rate is 0 [%]; and set the duty to 50% when the dimming rate is 50 [%]. That is, the signal receiver 31 may control the constant current circuit 32 so that the light source 33 is adjusted to the instructed dimming rate.

Preferably, the constant current circuit 32 is configured to receive the output voltage V2 from the two power supply lines E21 and E22 to supply a load current to the light source 33, thereby lighting the light source 33. The constant current circuit 32 may be configured to increase or decrease the load current flowing through the light source 33 (a current value thereof), thereby adjusting the dimming rate of the light source 33. The constant current circuit 32 is, for example a step-down switching converter.

Preferably, the light source 33 has solid light emitting devices 331. Each of the solid light emitting devices 331 is, for example an LED (Light Emitting Diode). The solid light emitting devices 331 may be connected in series.

An example of a transmission process of the transmission signal by the signal transmitter 2 will be explained in detail.

Examples of the operation mode of the communication controller 225 include a steady mode, a communication mode and a stop mode.

When the signal transmitter 2 is activated, the communication controller 225 sets the operation mode to the steady mode. The communication controller 225 under the steady mode turns and keeps the first and second switches Q1 and Q2 off and on (nonconductive and conductive states), respectively, thereby adjusting so that the output voltage V2 is equal to the input voltage V1 (the output voltage V2 becoming the same state as that during a period of time T1 in FIG. 3). The communication controller 225 under the steady mode transmits no transmission signal to the light fixtures 3.

Note that “the output voltage V2 is equal to the input voltage V1” means not only the difference between the input voltage V1 and the output voltage V2 being zero but also the difference between the input voltage V1 and the output voltage V2 being a small value that can be regarded as substantially zero. For example, the output voltage V2 may have a smaller value than the input voltage V1 by a voltage drop caused by electronic components and the like constituting the step-down circuit 213.

Then, if one or more signals of the external instruction signal S1, the internal instruction signal S21 and the internal instruction signal S22 are supplied to the signal transmitter 2, an instruction signal S0 is supplied to the communication controller 225. The communication controller 225 supplied with the instruction signal S0 sets the operation mode to the communication mode. The communication controller 225 under the communication mode controls the first and second switches Q1 and Q2 as shown in FIG. 3, thereby changing the output voltage level to transmit a transmission signal to the light fixtures 3. Note that Vg1 and Vg2 in FIG. 3 are gate voltages of the first and second switches Q1 and Q2, respectively.

Specifically, the communication controller 225 under the communication mode controls the first and second switches Q1 and Q2 so that the output voltage level is switched between a first voltage level V21 and a second voltage level V22. The first voltage level V21 has, for example the same as the voltage value of the input voltage V1. For example, the second voltage level V22 has a value obtained by stepping down the input voltage V1 that has a smaller value than the first voltage level V21. In a specific example, the signal transmitter 2 includes a voltage detector circuit configured to detect the output voltage V2 to obtain a detection result. For example, the voltage detector circuit has a series circuit of resistors connected between both ends of the capacitor C2 (see FIG. 1), and is configured to divide the output voltage V2 by the resistors to obtain a divided voltage as the detection result. The communication controller 225 is configured to adjust the output voltage level to the first voltage level V21 by controlling the first and second switches Q1 and Q2 so that the detection result of the output voltage V2 accords with a voltage of a first target value. The communication controller 225 is also configured to adjust the output voltage level to the second voltage level V22 by controlling the first and second switches Q1 and Q2 so that the detection result of the output voltage V2 accords with a voltage of a second target value. Note that the voltage detector circuit is not indispensable, but may be replaced with another configuration as long as it can detect the output voltage V2 to obtain a detection result. For example, it may be an electric conductor (e.g., a conductive pattern) for detecting the output voltage V2 to provide the communication controller 225 with a detection result, which is electrically connected between a positive output terminal of the power supply 21 and the communication controller 225.

The transmission signal contains information for changing the lighting state of the light sources 33 that is information for changing the dimming rates of the light sources 33 in this example. The dimming rate means a level (a degree) of a light output of the light source 33, and the dimming rate (dimming ratio) is defined as 100[%] when the light source 33 is fully lit (lit at a rated output). The transmission signal contains a bit stream composed of a plurality of bits. The bit stream contains at least, object identification data that is identification data uniquely assigned to a light fixture 3 as a control object, and control data that represent the lighting state (dimming rate) of the light fixture 3 as the control object.

When a bit value of the transmission signal is “1”, the communication controller 225 under the communication mode periodically repeats turning on and off the first switch Q1 (preferably at a constant cycle) with the second switch Q2 kept in an Off state, thereby decreasing the output voltage V2 from the first voltage level V21. As a result, an electric charge of the capacitor 2 is discharged, and the output voltage V2 decreases from the first voltage level V21 to the second voltage level V22 (a period of time T2 in FIG. 3).

Specifically, when the first and second switches Q1 and Q2 are in On and Off states, respectively, the electric charge stored in the capacitor 2 is discharged through a path (a discharge path) of the terminal on the high potential side of the capacitor C2, the first switch Q1, the inductor L1 and the terminal on the low potential side of the capacitor C2. In this case, the signal transmitter 2 has a possibility that a current flowing through the inductor L1 (an inductor current) will increase and the inductor current will exceed the rated current of the inductor L1. Therefore, in order to prevent the inductor current from exceeding the rated current, the communication controller 225 turns the first switch Q1 on with the second switch Q2 kept in an Off state, and turns the first switch Q1 off with the second switch Q2 kept in an Off state, when a (first) prescribed time elapses. The prescribed time is, for example 0.1 [ms]. When the first switch Q1 is turned off with the second switch Q2 kept in the Off state, the discharge path is changed to a path of the terminal on the high potential side of the capacitor C2, the capacitor C1, the second diode D2 of the second switch Q2, the inductor L1 and the terminal on the low potential side of the capacitor C2. The inductor current also decreases when the first switch Q1 is turned off with the second switch Q2 kept in the Off state.

When a (second) prescribed time elapses after the first switch Q1 is turned off with the second switch Q2 kept in the Off state, the communication controller 225 turns the first switch Q1 on with second switch Q2 kept in the Off state. The second prescribed time is, for example 0.1 [ms].

That is, when the bit value of the transmission signal changes from “0” to “1”, the communication controller 225 repeatedly alternates between first control in which the first switch is turned on with the second switch Q2 kept in the Off state and second control in which the first switch is turned off with the second switch Q2 kept in the Off state. It is accordingly possible to discharge the electric change stored in the capacitor C2 while preventing the inductor current from exceeding the rated current.

If the output voltage V2 decreases and then reaches the second voltage level V22, the communication controller 225 periodically repeats turning on and off the second switch Q2 (preferably at a fixed cycle) with the first switch Q1 kept in an Off state (see a period of time T3 in FIG. 3). The communication controller 225 can accordingly keep the output voltage V2 at the second voltage level V22 (see the period of time T3 in FIG. 3).

The communication controller 225 then transmit each bit information of the transmission signal at a cycle T0. That is, the sum of the period of time T2 and the period of time T3 (T2+T3) equals the cycle T0. Note that the cycle T0 is set to be, for example 5 [ms].

In the example of FIG. 3, a subsequent bit value of the transmission signal is “0”. The communication controller 225 under the communication mode repeatedly turns the second switch Q2 on and off with the first switch Q1 kept in the Off state (a period of time T4 in FIG. 3). The communication controller 225 can therefore increase the output voltage V2 from the second voltage level V22 to the first voltage level V21.

If the output voltage V2 increases and then reaches the first voltage level V21, the communication controller 225 keeps the second switch Q2 in an On state with the first switch Q1 kept in the Off state so that the output voltage V2 is kept at the first voltage level V21 (a period of time T1 in FIG. 3). A sum of the period of time T1 and the period of time T4 (T1+T4) equals the cycle T0.

The communication controller 225 under the communication mode then repeats the abovementioned operation in accordance with a bit value of the transmission signal. Note that when the bit value “0” is continuously transmitted by the transmission signal, the operation during the period of time T1 is repeated even in a subsequent cycle T0. In addition, when the bit value “1” is continuously transmitted by the transmission signal, the operation during the period of time T3 is repeated even in a subsequent cycle T0.

Preferably, the communication controller 225 under the communication mode makes a ratio of the period of time T3 to the cycle T0 (T3/T0) as short as possible when a bit value of the transmission signal is “1”. In this case, it is possible to suppress variations in electric power to be supplied to the light fixtures 3 and the flicker of the light sources 33 during the communication.

Preferably, the communication controller 225 under the communication mode is provided with start and stop bits at the start and end of the transmission signal, respectively. The start bit is a bit or a bit stream, for representing the start of the transmission signal. The stop bit is a bit or a bit stream, for representing the end of the transmission signal. For example, the start bit is a bit stream of “111”, and the stop bit is a bit stream of “000”. However, when the transmission signal has a signal length of a fixed length, each light fixture 3 can judge the end of the transmission signal even if the stop bit is not transmitted.

The communication controller 225 has completed transmitting the transmission signal, and then changes the operation mode from the communication mode to the steady mode to keep the output voltage level of the power supply 21 at the first voltage level V21.

The communication controller 225 further has the stop mode as the operation mode. The stop mode is a mode for stopping the output of the step-down circuit 213. For example, when an abnormality (a malfunction) occurs in the signal transmitter 2, the communication controller 225 selects the stop mode as the operation mode. The communication controller 225 under the stop mode keeps each of the first and second switches Q1 and Q2 in an Off state. The communication controller 225 can accordingly stop the power supply to the light fixtures 3 because the output voltage V2 becomes zero. Note that the communication controller 225 under the stop mode may keep only the second switch Q2 in an Off state. That is, the communication controller 225 may be configured to keep at least the second switch Q2 in an Off state when the operation mode is the stop mode.

In the above example, the signal transmitter 2 transmits the transmission signal by changing the output voltage V2, specifically the output voltage level of the power supply 21. The signal transmitter 2 can therefore reduce noise caused by the transmission of the transmission signal and a leakage of the transmission signal in comparison with the configuration in which a high frequency transmission signal is output with the transmission signal superposed on a DC voltage.

In the example, the signal transmitter 2 transmits the transmission signal by changing the output voltage level. It is accordingly possible to suppress the attenuation of the transmission signal, caused by the inductance of the two power supply lines E21 and E22. The signal transmitter 2 can therefore stabilize signal transmission and lengthen the transmission distance in comparison with the configuration in which a high frequency transmission signal is output with the transmission signal superposed on a DC voltage.

In the example, the signal transmitter 2 transmits the transmission signal by controlling the first and second switches Q1 and Q2 to change the output voltage V2 (the output voltage level), as stated above. The signal transmitter 2 can therefore transmit the transmission signal with a comparatively simple configuration (circuit configuration). For example, the signal transmitter 2 can comparatively decrease the number of switches constituting the transmitter and decrease a conduction loss of the switches. That is, the signal transmitter 2 can reduce the transmission loss.

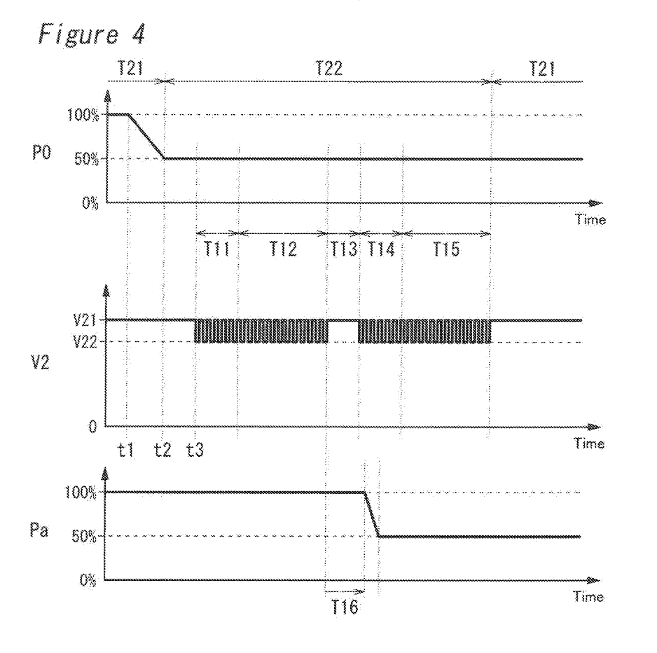

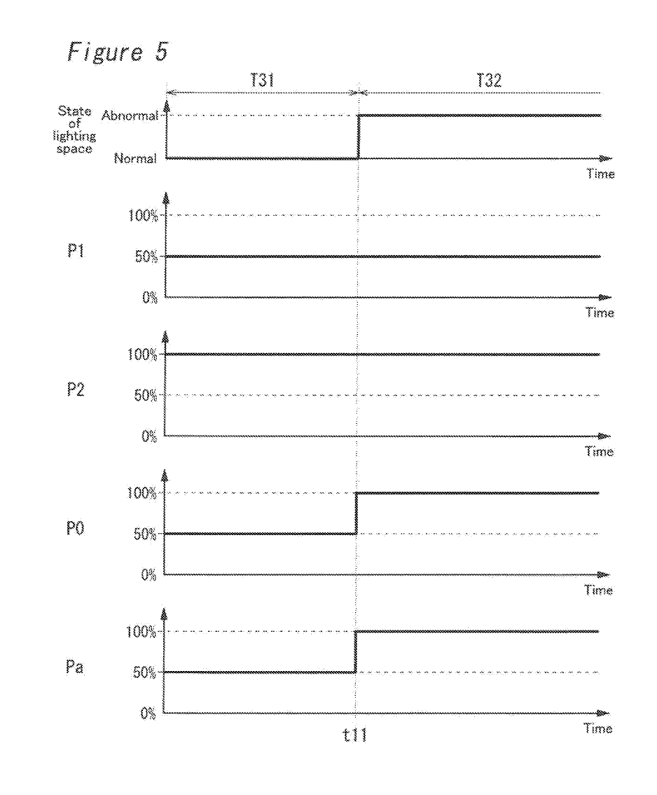

FIG. 4 shows an example of an operation of the signal transmitter 2 when the operation mode of the communication controller 225 is switched from the steady mode to the communication mode. Note that, in FIG. 4, P0 represents a dimming rate instructed by the instruction signal S0 (an instructed dimming rate) and Pa represents an actual dimming rate of a light source 33 (an actual dimming rate).

The communication controller 225 is supplied with the instruction signal S0 for changing the instructed dimming rate P0 to 50% (a time t1 in FIG. 4). In FIG. 4, a period of time between the time t1 and a time t2 is a period of time that the communication controller 225 needs to recognize that the instructed dimming rate P0 changes from 100% to 50%. After receiving the instruction signal S0, the communication controller 225 switches the operation mode from the steady mode to the communication mode. Note that, in FIG. 4, a period of time T21 is a period of time during which the operation mode is the steady mode and a period of time T22 is a period of time during which the operation mode is the communication mode.

If a predetermined waiting time elapses from the time t2 (a time t3 in FIG. 4), the communication controller 225 starts transmitting the transmission signal (a first transmission). The transmission signal to be transmitted from the communication controller 225 contains the object identification data and the control data. The object identification data to be contained in the transmission signal represent identification data of a light fixture 3 as a control object, and the control data to be contained in the transmission signal represent the instructed dimming rate P0. In FIG. 4, a period of time T11 is a period of time during which the object identification data are transmitted, and a period of time T12 is a period of time during which the control data are transmitted.

The communication controller 225 retransmits the same transmission signal when a period of time T13 elapses from the first transmission of the transmission signal (a second transmission). In FIG. 4, a period of time T14 is a period of time during which the object identification data are retransmitted, and a period of time T15 is a period of time during which the control data are retransmitted.

Each signal receiver 31 of the light fixtures 3 stores identification data assigned to its own light fixture 3 in advance. If the object identification data contained in the received transmission signal accord with the identification data of the light fixture 3, the signal receiver 31 judges that the control object is the light fixture 3, and then reads the control date contained in the transmission signal. If the object identification data contained in the received transmission signal do not accord with the identification data of the light fixture 3, the signal receiver 31 discards the transmission signal. The signal receiver 31 of the light fixture 3 as the control object controls the constant current circuit 32 so that the actual dimming rate Pa of the light source 33 accords with the instructed dimming rate P0. In the light fixture 3 as the control object shown in the example of FIG. 4, the actual dimming rate Pa changes from 100% to 50% after a period of time T16 elapses from the first reception of the transmission signal. If the second transmission process is finished, the communication controller 225 switches the operation mode from the communication mode to the steady mode. Note that the data volume of the identification data is, for example about 3 to 10 bits. The data volume of the control data is, for example about 8 to 10 bits.

When the light fixtures 3 constitute one group and group identification data is assigned to the group, the communication controller 225 may set the group identification data to the object identification data. In this case, the communication controller 225 can control the actual dimming rate Pa of the light fixtures 3 in the group in a lump.

For example, when the number of light fixtures 3 is five, the five light fixtures 3 are assigned respective identification data of “1” to “5”. In this example, when the five light fixtures 3 are dealt as a first group, group identification data of the first group are assigned “11”. When the light fixtures 3 with identification data of “1” to “3” are dealt as a second group, group identification data of the second group are assigned “12”. When the light fixtures 3 with identification data of “4” and “5” are dealt as a third group, group identification data of the third group are assigned “13”.

In this example, the communication controller 225 sets any one of “1” to “5” to the object identification data contained in the transmission signal in order to individually control the five light fixtures 3. The communication controller 225 also sets “11” to the object identification data contained in the transmission signal in order to control the light fixtures 3 of the first group in a lump. The communication controller 225 also sets “12” to the object identification data contained in the transmission signal in order to control the light fixtures 3 of the second group in a lump. The communication controller 225 also sets “13” to the object identification data contained in the transmission signal in order to control the light fixtures 3 of the third group in a lump.

The lighting state to be represented by the transmission signal is not limited to the dimming rate, but the transmission signal may contain a lighting state such as a color temperature (color adjustment), lighting, extinguishing or flashing.

An example of an operation of the signal selector 223 in the signal transmitter 2 will be explained.

The controller 4 generates the external instruction signal S1 according to detection results of sensors 5 (the illuminance sensor 51, the motion sensor 52, the fire sensor 53 and the like). For example, when the illuminance in the lighting space A1 detected with the illuminance sensor 51 is lower than the threshold, the controller 4 outputs the external instruction signal S1 for increasing the actual dimming rate Pa of the light fixtures 3. When the illuminance in the lighting space A1 detected with the illuminance sensor 51 is higher than the threshold, the controller 4 outputs the external instruction signal S1 for decreasing the actual dimming rate Pa of the light fixtures 3. When the motion sensor 52 detects human presence in the lighting space A1, the controller 4 outputs the external instruction signal S1 for turning the light fixtures 3 on. When the motion sensor 52 does not detect human presence in the lighting space A1, the controller 4 outputs the external instruction signal S1 for turning the light fixtures 3 off.

On the other hand, the internal instruction signal S21 is produced as a result of a user operating the operation unit 24. The internal instruction signal S22 is produced as a result of a user operating the remote control device 6.

The signal selector 223 preferentially selects any one of the external instruction signal S1 and the internal instruction signal S21 according to a preset selection rule when receiving both of the external instruction signal S1 and the internal instruction signal S21.

In a first example, the signal selector 223 operates according to a first selection rule for preferentially selecting an instruction signal containing the lowest instructed dimming rate.

In the example, P1 represents the instructed dimming rate contained in the external instruction signal S1, and P2 represents the instructed dimming rate contained in the internal instruction signal S2. In this case, the signal selector 223 selects a lower instructed dimming rate from the external instruction signal S1 and the internal instruction signal S2. If the instructed dimming rate P1 is lower than the instructed dimming rate P2, the signal selector 223 selects the external instruction signal S1. If the instructed dimming rate P2 is lower than the instructed dimming rate P1, the signal selector 223 selects the internal instruction signal S2.

As another example, the signal selector 223 preferentially selects any one of the internal instruction signals S21 and S22 according to the first selection rule when receiving both of the internal instruction signals S21 and S22.

In this example, P21 represents the instructed dimming rate contained in the internal instruction signal S21, and P22 represents the instructed dimming rate contained in the internal instruction signal S22. In this case, the signal selector 223 selects a lower instructed dimming rate from the internal instruction signals S2 land S22. If the instructed dimming rate P21 is lower than the instructed dimming rate P22, the signal selector 223 selects the internal instruction signal S21. If the instructed dimming rate P22 is lower than the instructed dimming rate P21, the signal selector 223 selects the internal instruction signal S22.

That is, the signal selector 223 preferably selects, as the instruction signal S0, an instruction signal containing the lowest instructed dimming rate of the external instruction signal S1 and the internal instruction signals S21 and S22. It is accordingly possible to suppress power consumption of the light sources 33 to improve energy saving.

In a second example, the signal selector 223 operates according to a second selection rule for preferentially selecting an instruction signal containing the lowest color temperature to be adjusted. In this case, the signal selector 223 selects, as the instruction signal S0, an instruction signal containing the lowest color temperature to be adjusted, from the external instruction signal S1 and the internal instruction signals S21 and S22.

In a third example, the signal selector 223 operates according to a third selection rule for preferentially selecting an instruction signal containing the lowest dimming rate when each of the instruction signals contains both of a dimming rate and a color temperature. In this case, the signal selector 223 selects, as the instruction signal S0, an instruction signal containing the lowest instructed dimming rate from the external instruction signal S1 and the internal instruction signals S21 and S22.

The signal selector 223 may operate according to a selection rule for preferentially selecting any one of the external instruction signal S1 and the internal instruction signals S2 according to a state of the lighting space A1.

Examples of the state of the lighting space A1 include “normal” and “abnormal” states. In this case, the signal selector 223 operates according to a fourth selection rule for preferentially selecting the external instruction signal S1 in the case of the normal state while preferentially selecting the internal instruction signals S2 in the case of the abnormal state, and for preferentially selecting any one internal instruction signal containing a higher instructed dimming rate from the internal instruction signals S21 and S22 when receiving both of the internal instruction signals S21 and S22 in the case of the abnormal state.

The controller 4 can judge whether the lighting space A1 is in the normal state or the abnormal state based on a detection result(s) by the sensors 5. For example, the controller 4 judges that the lighting space A1 is in the abnormal state, in case the fire sensor 53 detects the occurrence of fire in the lighting space A1. The controller 4 judges that the lighting space A1 is in the normal state, in case the fire sensor 53 does not detect the occurrence of fire. The controller 4 judges that the lighting space A1 is in the abnormal state, in case the motion sensor 52 detects intrusion (intruder) into the lighting space A1. The controller 4 judges that the lighting space A1 is in the normal state, in case the motion sensor 52 detects no intrusion into the lighting space A1. The state of the lighting space A1 is not limited to the occurrence of fire or the detection of intrusion, but examples of the state of the lighting space A1 may further include an operation state of a machine in the lighting space A1 and the occurrence of earthquakes.

The controller 4 transmits an abnormal signal S3 to the signal transmitter 2 via the communication cable W1 when judging that the lighting space A1 is in the abnormal state. The external signal receiver 221 receives the abnormal signal S3 from the controller 4 via the wire connector 23, and then supplies the abnormal signal S3 to the signal selector 223. The signal selector 223 can recognize that the lighting space A1 is in any of the normal state and the abnormal state based on the abnormal signal S3. Note that in FIG. 1 the external instruction signal S1 and the abnormal signal S3 are transmitted to the signal selector 223 via the same path from the external signal receiver 221. However, the external instruction signal S1 and the abnormal signal S3 may be transmitted to the signal selector 223 via individual paths from the external signal receiver 221.

FIG. 5 shows an example of an operation of the signal selector 223 according to the fourth selection rule. In FIG. 5, T31 represents a normal time period during which no abnormal signal S3 occurs, and T32 represents an abnormal time period during which the abnormal signal S3 occurs.

In the example of FIG. 5, during the normal time period T31, the instructed dimming rate P1 of the external instruction signal S1 is 50%, and an instructed dimming rate P2 of the internal instruction signal S2 (an internal instruction signal S21 or S22) is 100%. In this case, the lighting space A1 is in the normal state, and therefore the signal selector 223 outputs the external instruction signal 51 as the instruction signal S0. That is, the instructed dimming rate P0 contained in the instruction signal S0 equals the instructed dimming rate P1 (=50%) contained in the external instruction signal 51. Therefore, in the light fixture(s) 3 as the control object, the actual dimming rate Pa of the light source(s) 33 is adjusted to 50%.

The abnormal state occurs at a time t11, and the signal selector 223 outputs the internal instruction signal S2 as the instruction signal S0 during an abnormal time period T32 from the time t11. That is, the instructed dimming rate P0 contained in the instruction signal S0 equals the instructed dimming rate P2 (=100%) contained in the internal instruction signal S2. Therefore, in the light fixture(s) 3 as the control object, the actual dimming rate Pa of the light source(s) 33 is adjusted to 100%.

Thus, it is possible to improve safety when the lighting space A1 is in the abnormal state, by prioritizing an operational instruction of the remote control device 6 and the operation unit 24 in the lighting space A1 in order to prioritize a person's safety in the lighting space A1 when the lighting space A1 is in the abnormal state. The abnormal state may be detected in response to the user's operation of the operation unit 24 or the like.

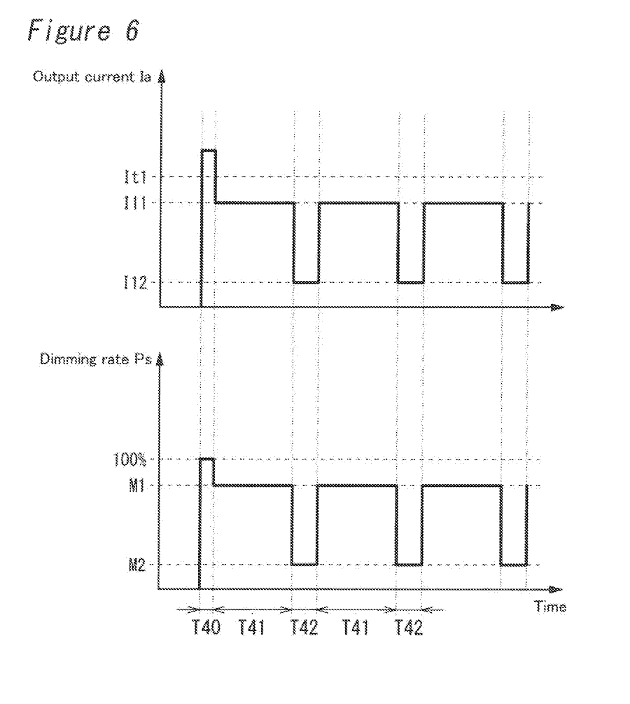

Preferably, the signal transmitter 2 has an overload inhibitory function for preventing the failure by overload. The overload inhibitory function will be explained with reference to FIG. 6.

Preferably, the detector 26 is configured to detect (measure) a current value of a current I1 flowing between a negative electrode of the capacitor C1 and the source of the second switch Q2 (a detection current I1). The detector 26 may include a resistor R1 and an amplifier circuit 261.

A first end of the resistor R1 may be electrically connected to the negative electrode of the capacitor C1. A second end of the resistor R1 may be electrically connected to the source of the second switch Q2. The amplifier circuit 261 may be configured to amplify a voltage between both ends of the resistor R1 by the detection current I1 to supply the judgement controller 224 with the amplified voltage as a detection value Vs.

Preferably, the judgement controller 224 is configured to monitor an output current Ia of the signal transmitter 2. In the embodiment, the judgement controller 224 is configured to not directly monitor the output current Ia but indirectly monitor the output current Ia based on the detection value Vs of the detection current I1. In this case, the judgement controller 224 is configured to receive the detection value Vs from the detector 26 to monitor the output current Ia as a monitor value based on the detection value Vs. The judgement controller 224 is further configured to judge whether the output current Ia as the monitor value is greater than or equal to a first prescribed value It1 by judging whether the detection value Vs is greater than or equal to a prescribed value. That is, the judgement controller 224 is to judge that an overload state in which the monitor value is excessive when the output current Ia is greater than or equal to the first prescribed value It1.

The first prescribed value It1 is, for example a maximum allowed current of the signal transmitter 2. The maximum allowed current means a limit (a maximum value) of a load current that is allowed to continuously flow through a load without hindrance for practical purposes. The maximum allowed current of the signal transmitter 2 has a current value that is, for example 80% of the rerated current of the signal transmitter. The maximum allowed current of the signal transmitter 2 also corresponds to the number of the light fixtures 3 that are allowed to be electrically connected to the signal transmitter 2 (connection allowable number). In the embodiment, the connection allowable number of the signal transmitter 2 is represented as “N”. Note that the maximum allowed current of the signal transmitter 2 may be a value obtained by considering a usage environment temperature (an ambient temperature) of the signal transmitter 2.

Preferably, the judgement controller 224 is configured to notify the judgement result to the communication controller 225. Preferably, the communication controller 225 is configured to send out a transmission signal that represents a dimming rate to make the output current Ia smaller than the first prescribed value It1, when the judgement controller 224 judges that the output current Ia is greater than or equal to the first prescribed value It1.

Specifically, when the judgement controller 224 judges that the output current Ia is greater than or equal to the first prescribed value It1, the communication controller 225 may change a dimming rate Ps to be instructed by the transmission signal to a first dimming rate M1 in order to make the output current Ia smaller than the first prescribed value It1. The first dimming rate M1 is, for example smaller than a dimming rate (in FIG. 6, 100%) before the judgement controller 224 judges that the output current Ia is greater than or equal to the first prescribed value It1. The communication controller 225 can decrease the output current Ia of the signal transmitter 2 to a value that is less than the prescribed value (in FIG. 6, It1). The signal transmitter 2 can accordingly suppress the occurrence of failure caused by overload.

Preferably, the communication controller 225 is configured to transmit the transmission signal while alternately switching the dimming rate Ps between the first dimming rate M1 and a second dimming rate M2, after changing the dimming rate Ps to the first dimming rate M1. The second dimming rate M2 is, for example smaller than a dimming rate when the output current Ia equals the first prescribed value It1. The second dimming rate M2 is smaller than the first dimming rate M1. In this case, the communication controller 225 may set each of a period of time T41 and a period of time T42 to a period of time during which a change in light output of the light source 33 is visible to the naked eye, where the period of time T41 is a period of time during which the dimming rate Ps is the first dimming rate M1, and the period of time T42 is a period of time during which the dimming rate Ps is the first dimming rate M2. Each of the period of time T41 and the period of time T42 is, for example about several seconds.

Hereinafter, an operation of the signal transmitter 2 when a new light fixture 3 is added to N light fixtures 3 will be explained. Note that in the example below the new light fixture 3 is added when all the N light fixtures 3 are turned off, and then all the light fixtures 3 are fully lit. The dimming rate of each light source 33 in the light fixtures 3 when they are fully lit is, for example 100%.

In the signal transmitter 2, when the new light fixture 3 is added to the N light fixtures 3, the number of the light fixtures 3 exceeds the connection allowable number and therefore the output current I1 exceeds the maximum allowed current. That is, with the signal transmitter 2, when the new light fixture 3 is added to the N light fixtures 3, the output current Ia becomes the first prescribed value It1 or more.

Preferably, when the judgement controller 224 judges that the output current Ia is greater than or equal to the first prescribed value It1 (in FIG. 6, a period of time T40), the communication controller 225 changes the dimming rate Ps to be instructed by the transmission signal to the first dimming rate M1. As a result, the output current Ia is decreased to below the first prescribed value It1. In the example of FIG. 6, after the dimming rate Ps to be instructed by the transmission signal is changed from 100% to the first dimming rate M1, the communication controller 225 changes the dimming rate Ps so that the first dimming rate M1 during the period of time T41 and the second dimming rate M2 during the period of time T42 are alternately repeated. In FIG. 6, I11 represents a value of the output current Ia when the dimming rate Ps is the first dimming rate M1, and 112 represents a value of the output current Ia when the dimming rate Ps is the first dimming rate M2. In FIG. 6, T40 represents a period of time from when the output current Ia is greater than or equal to the first prescribed value It1 to when the dimming rate Ps is change from 100% to the first dimming rate M1 (detection time). The period of time T40 is, for example about several milliseconds. The second dimming rate M2 is, for example a low dimming rate by which a change in light output of each light source 33 is visible to the naked eye (a person such as a contractor). However, the second dimming rate M2 is not limited to the low dimming rate by which a change in light output of each light source 33 is visible to the naked eye. The second dimming rate M2 may be a dimming rate for turning the light sources 33 off.

As stated above, when the new light fixture 3 is added to the N light fixtures 3, the signal transmitter 2 decreases the dimming rate Ps to be instructed by the transmission signal so that the output current Ia is less than the first prescribed value It1. The signal transmitter 2 can accordingly make the output current Ia smaller than the maximum allowed current. That is, when the number of light fixtures 3 exceeds the connection allowable number N, the signal transmitter 2 decreases respective light outputs of the light sources 33 of the light fixtures 3 and dims the light sources 33 of all the light fixtures 3. The signal transmitter 2 can therefore suppress the occurrence of failure caused by overload.

In addition, the signal transmitter 2 transmits the transmission signal so that the first dimming rate M1 and the second dimming rate M2 are alternately repeated after the dimming rate Ps to be instructed by the transmission signal is changed to the first dimming rate M1, in order to make the output current Ia less than the first prescribed value It1. As a result, the signal transmitter 2 can notify the overload to the contractor or the like.

Therefore, the signal transmitter 2 according to the embodiment can suppress the occurrence of failure caused by overload and notify users (e.g., contractor or the like) of the overload by dimming or turning off the light fixtures 3.

Note that the second dimming rate M2 may be greater than the first dimming rate M1. It is however necessary to make the second dimming rate M2 smaller than a dimming rate when the output current Ia equals the first prescribed value It1. In this case, the second dimming rate M2 is greater than the first dimming rate M1, and smaller than the dimming rate when the output current Ia equals the first prescribed value It1.

FIG. 6 illustrates the operation of the signal transmitter 2 when a new light fixture 3 is added to the N light fixtures 3 when they are unlit, and then all the light fixtures 3 are fully lit. However, like operation may be performed even if the new light fixture 3 is added to the N light fixtures 3 when they are lit.

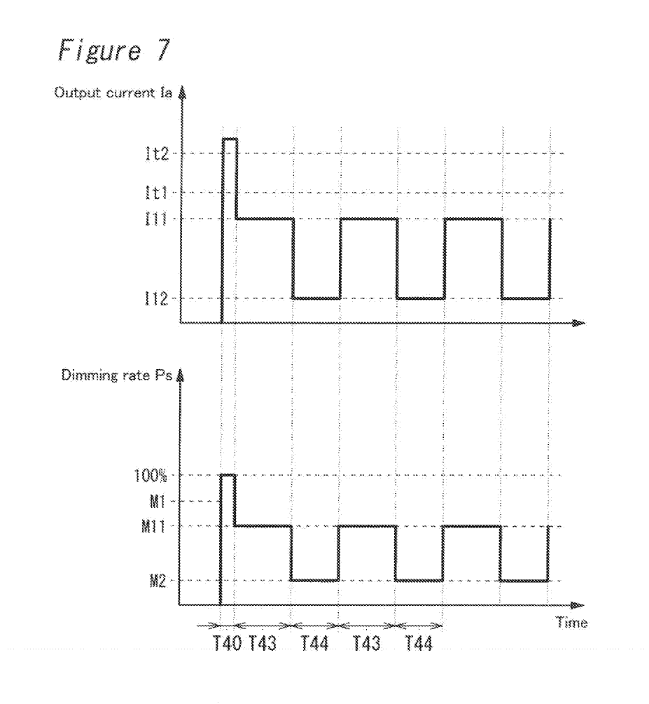

As shown in FIG. 7, it is preferable that the communication controller 225 be configured to make the first dimming rate lower as a difference between a value of the output current Ia and the first prescribed value It1 is greater, when the judgement controller 224 judges that the value of the output current Ia is greater than or equal to the first prescribed value It1.

Specifically, the judgement controller 224 has, as the prescribed value, the first prescribed value It1 and a second prescribed value It2 and the communication controller 225 has, as the first dimming rate, first dimming rates M1 and M11. In the example of FIG. 7, the second prescribed value It2 is greater than the first prescribed value It1, and the first dimming rate M11 is lower than the first dimming rate M1. When the judgement controller 224 judges that the value of the output current Ia is greater than or equal to the first prescribed value It1, and less than the second prescribed value It2, the communication controller 225 changes the dimming rate Ps to be instructed by the transmission signal to the first dimming rate M1 (as illustrated in FIG. 6). When the judgement controller 224 judges that the value of the output current Ia is greater than or equal to the second prescribed value It2, the communication controller 225 changes the dimming rate Ps to be instructed by the transmission signal to the first dimming rate M11 (as illustrated in FIG. 7).

That is, the first dimming rate M11 when the value of the output current Ia is greater than or equal to the second prescribed value It2 is made smaller than the first dimming rate M1 when the value of the output current Ia is greater than or equal to the first prescribed value It1 and less than the second prescribed value It2. In the embodiment, data of the first prescribed value It1 and the second prescribed value It2 and data of the first dimming rates M1 and M11 are stored in a memory of the main controller 22.

Therefore, when the value of the output current Ia is greater than or equal to the second prescribed value It2, the signal transmitter 2 can further suppress the occurrence of failure caused by overload by making the first dimming rate smaller than that when the value of the output current Ia is greater than or equal to the first prescribed value It1 and less than the second prescribed value It2. Note that for example, the number of new light fixtures 3 added to the N light fixtures 3 is two or more, when the value of the output current Ia is greater than or equal to the second prescribed value It2.

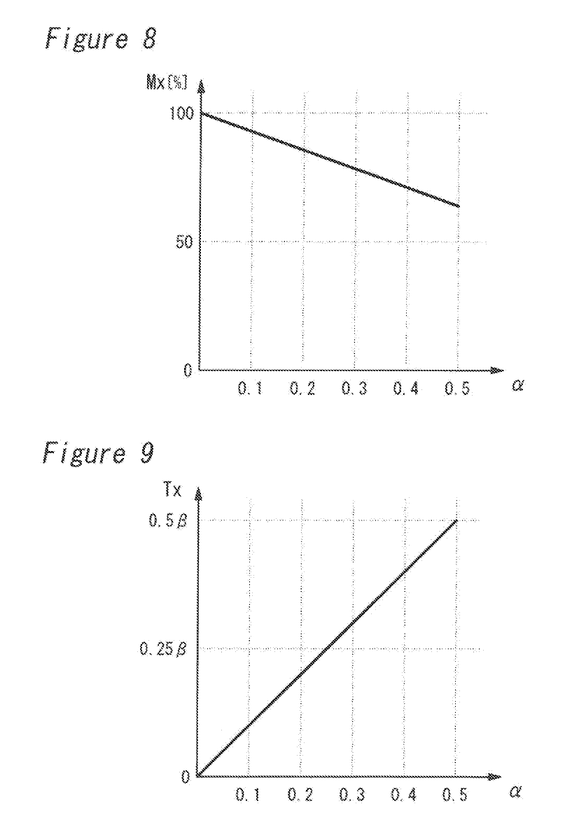

Preferably, the communication controller 225 makes the first dimming rate smaller as the number of new light fixtures 3 added to the N light fixtures 3 more increases. Specifically, the communication controller 225 may make the first dimming rate smaller as a difference between the value of the output current Ia and the first prescribed value It1 is greater. That is, the communication controller 225 may make a first dimming rate Mx smaller as an excess rate a of the output current Ia is greater as shown in FIG. 8. The excess rate a of the output current Ia and the first dimming rate Mx are respectively given by

a={(Value of Output Current Ia)/First Prescribed Value It1}−1, and Mx={1/(1+a)}×100,

where 0≦Mx≦100.

Correlation characteristics in FIG. 8 show that the first dimming rate Mx linearly decreases as the excess rate a of the output current Ia increases, but is not limited to this. The present embodiment may have correlation characteristics showing that the first dimming rate Mx nonlinearly decreases (e.g., along a curved line) as the excess rate a increases or that the first dimming rate Mx stepwise decreases as the excess rate a increases.

Preferably, a period of time T43 of the first dimming rate M11 (see FIG. 7) is shorter than the period of time T41 of the first dimming rate M1 (see FIG. 6). That is, the period of time T43 of the first dimming rate M11 to be set when the output current Ia is greater than or equal to the second prescribed value It2 is shorter than the period of time T41 of the first dimming rate M1 to be set when the output current Ia is greater than or equal to the first prescribed value It1 and less than the second prescribed value It2.

Preferably, a period of time T44 of the second dimming rate M2 (see FIG. 7) is longer than the period of time T42 (see FIG. 6). That is, the period of time T44 of the second dimming rate M2 to be set when the value of the output current Ia is greater than or equal to the second prescribed value It2 is longer than the period of time T42 of the second dimming rate M2 to be set when the value of the output current Ia is greater than or equal to the first prescribed value It1 and less than the second prescribed value It2.

Therefore, the signal transmitter 2 can quickly start changing respective light outputs of the light sources 33 to quickly notify overload to a person such as a contractor. The signal transmitter 2 also facilitates recognition of a change in light output of each light source 33 by the person such as the contractor. In the embodiment, data of the period of time T41 to the period of time T44 are stored in the memory of the main controller 22.

It is preferable that a sum of the period of time of the first dimming rate and the period of time of the second dimming rate be constant. In this case, T41+T42=T43+T44. However, the sum of the period of time of the first dimming rate and the period of time of the second dimming rate is not necessarily constant.

The period of time T43 is not necessarily shorter than the period of time T41, but may be the same as the period of time T41.

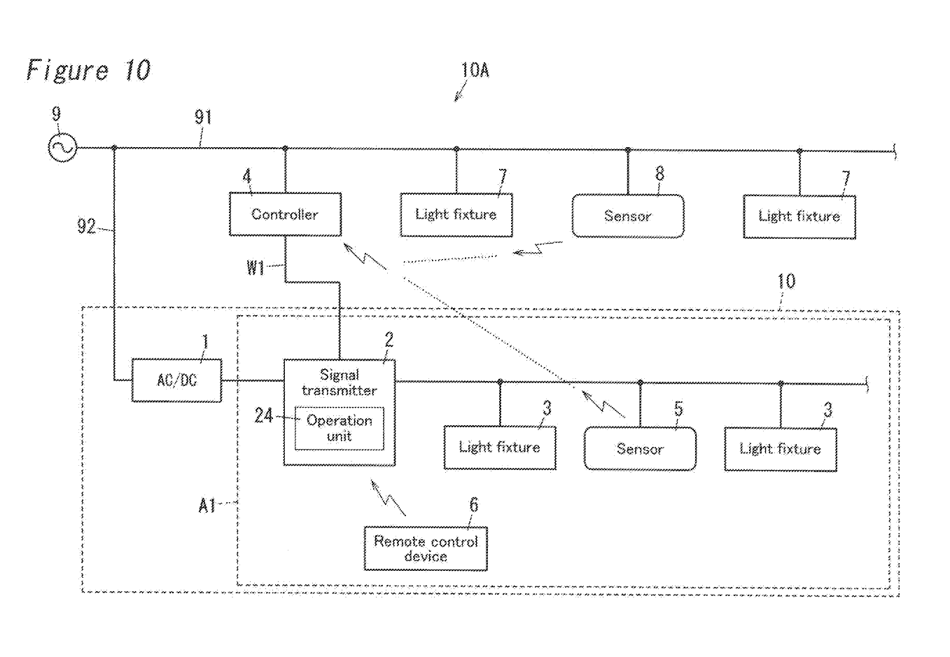

Preferably, the communication controller 225 makes the period of time of the second dimming rate M2 longer as the number of new light fixtures 3 to be added to the N light fixtures 3 increases. Specifically, the communication controller 225 may make the period of time of the second dimming rate M2 longer as the difference between the value of the output current Ia and the first prescribed value It1 is greater. That is, the communication controller 225 may make the period of time of the second dimming rate M2 (length of time Tx) longer as the excess rate a of the output current Ia becomes greater as shown in FIG. 9. The period of time of the second dimming rate (length of time Tx) is given by

Tx=β×α,

where β is an arbitrary value (e.g., 10).

Correlation characteristics in FIG. 9 show that the period of time of the second dimming rate (length of time Tx) linearly decreases as the excess rate a of the output current Ia becomes greater, but is not limited to this. The present embodiment may have correlation characteristics showing that the length of time Tx nonlinearly increases (e.g., along a curved line) as the excess rate a of the output current Ia becomes greater or that the length of time Tx stepwise increases as the excess rate a becomes greater.

Preferably, the communication controller 225 is configured to set the dimming rate Ps to be instructed by the transmission signal based on the instruction signal S0 from the signal selector 223 and the judgement result by the judgement controller 224. For example, when the judgement controller 224 judges that the output current Ia is greater than or equal to the first prescribed value It1 after the communication controller 225 receives the instruction signal S0 from the signal selector 223, the communication controller 225 makes the dimming rate Ps to be instructed by the transmission signal smaller than the instructed dimming rate P0 of the instruction signal S0. The signal transmitter 2 can accordingly suppress the occurrence of failure caused by overload.

The detector 26 is configured to detect (measure), as the monitor value, the value of the output current Ia of the signal transmitter 2, but not limited thereto. The detector 26 may be configured to detect (measure), as the monitor value, a value of the output voltage V2 of the signal transmitter 2. In this case, the output current of the signal transmitter 2 is controlled constant.

The detector 26 may be configured to detect (measure), as the monitor value, one of an input current or input voltage V1 of the signal transmitter 2. The detector 26 may be configured to detect (measure), as the monitor value, one of output power or input power of the signal transmitter 2.

Even if the monitor value is any of the input current, the output current Ia, the input voltage V1, the output voltage V2, the input power and the output current, the signal transmitter 2 can notify users that the monitor value is greater than or equal to the prescribed value.

When transmitting a transmission signal that represents a dimming rate and a color temperature, the communication controller 225 preferably operates based on a judgment result by the judgement controller 224 as stated below.

For example, when the judgement controller 224 judges that the output current Ia is greater than or equal to the first prescribed value It1, the communication controller 225 transmits a transmission signal for changing only the dimming rate of the abovementioned dimming rate and the color temperature. Thus, the communication controller 225 changes only the dimming rate, thereby enabling a person such as contractor to easily recognize a change in light output of the light sources 33 in comparison with a case where both the dimming rate and the color temperature are changed.

Alternatively, the communication controller 225 may identify the light fixtures 3, thereby blinking only a light fixture(s) 3 that is(are) newly added and exceeds the connection allowable number N, or blinking not all the light fixtures 3 but only part thereof. Thus, blinking only the light fixture(s) 3 that is(are) newly added and exceeds the connection allowable number N, or only light fixtures 3 in the vicinity thereof enables the contractor or the like to more easily recognize the occurrence of overload. It is also possible to operate other light fixtures 3 at steady lighting to keep the light environment in normal state.

Note that when the judgement controller 224 judges that the monitor value is greater than or equal to the first prescribed value, the communication controller 225 changes the dimming rate Ps to be instructed by the transmission signal to the first dimming rate M1, but is not limited thereto. The communication controller 225 may change the dimming rate Ps to be instructed by the transmission signal to the first dimming rate M1, when the judgement controller 224 judges that the monitor value is greater than the first prescribed value.

In the lighting system 10, the main controller 22 may be configured to transmit a transmission signal containing data of the dimming rate Ps to the light fixtures 3 via a signal cable. In this case, the output unit 212 further includes signal terminals that allow the signal cable to be electrically connected to. The lighting system 10 further includes the signal cable for transmitting the transmission signal in addition to the two power supply lines E21 and E22.

The main controller 22 may be configured to transmit the transmission signal directly to the light fixtures 3. In this case, the main controller 22 is configured to transmit the transmission signal to the light fixtures 3 over wireless communication media such as radio wave, near infrared light or visible light, for example.

The lighting system 10 includes the N light fixtures. The N may be one or more. That is, the lighting system 10 may include one or more light fixtures 3.

Each of the input unit 211 and the output unit 212 is not limited to a connector, but may be a socket or the like. The AC/DC converter 1 is not limited to a step-up chopper circuit having a power-factor correction function, but may be, for example a rectifier circuit including rectifier diodes, or the like. Each of the first and second switches Q1 and Q2 is not limited to an N-channel enhancement MOSFET, but may be, for example a P-channel enhancement MOSFET or the like. A driver circuit for the first and second switches Q1 and Q2 is provided in the main controller 22 of the signal transmitter 2, but may be provided outside the main controller 22.

The main controller 22 is not limited to a microcomputer, but may be, for example an ASIC (Application Specific Integrated Circuit), an FPGA (Field Programmable Gate Array), a control IC (Integrated Circuit) or the like. Preferably, the main controller 22 includes at least a processor. The main controller 22 may include a memory which stores a program executable by the processor so as to carry out the control described herein.

The detector 26 includes the amplifier circuit 261, but need not include the amplifier circuit 261. In this case, the resistor R1 is electrically connected directly to the judgement controller 224.

Each of the solid light emitting devices 331 of each light source 33 is not limited to an LED, but may be a solid light emitting device other than the LED, such as an organic Electro Luminescence (OEL), a Laser Diode (LD) or the like. The number of solid light emitting devices 331 is not limited to two or more, but may be one. The solid light emitting devices 331 are connected in series, but not limited thereto. The solid light emitting devices 331 may be connected in parallel or in series-parallel.

Each light fixture 3 is not limited to a downlight, but may be, for example a spotlight or the like. The constant current circuit 32 of the light fixture 3 is not limited to a step-down chopper circuit, but may be, for example a step-up chopper circuit or a step-up/down chopper circuit. Each constant current circuit 32 is configured to control a light output of a corresponding light source 33 by PWM, but not limited thereto. For example, each constant current circuit 32 may be configured to control a light output of a corresponding light source 33 by amplitude modulation, or by PWM and amplitude modulation.

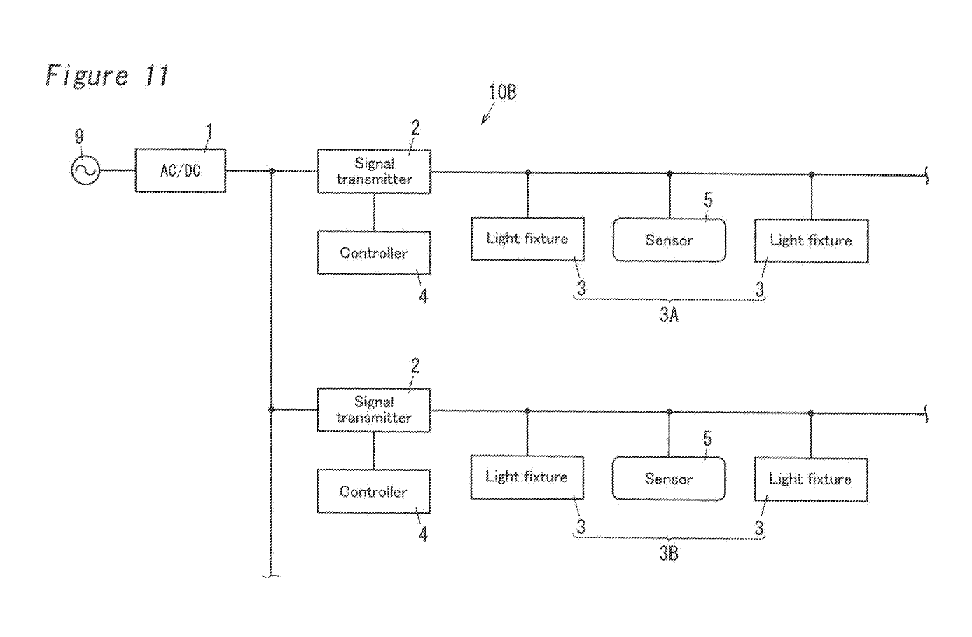

Hereinafter, a first modified example of the embodiment will be explained with reference to FIG. 10.

In the example of FIG. 10, a controller 4, light fixtures 7 and a sensor 8 are electrically connected to a first system 91 configured to be supplied with commercial power from the commercial power supply 9. The light fixtures 7 and the sensor 8 are disposed outside the lighting space A1 stated above.

The lighting system 10 stated above is connected to a second system 92 configured to be supplied with commercial power from the commercial power supply 9.

In the modified example, detection signals of the sensors 5 and 8 are transmitted to the controller 4 by wireless communication. The controller 4 is configured to communicate with the signal transmitter 2 via the communication cable W1. The controller 4 can therefore control the lighting states of the light fixtures 3 based on not only the detection signal of the sensor 5 but also a detection signal of the sensor 8.

Based on respective instruction signals from the controller 4, the remote control device 6 and the operation unit 24, the signal transmitter 2 can transmit the transmission signal to the light fixtures 3 to control the lighting states of the light fixtures 3.

A second modified example of the embodiment will be explained with reference to FIG. 11.

In a lighting system 10B shown in the example of FIG. 11, signal transmitters 2 are electrically connected to one AC/DC converter 1. Each of the signal transmitters 2 is configured to supply an output voltage V2 to its own light fixtures 3 and sensor 5 to perform lighting control like the abovementioned embodiment. Note that in FIG. 11 the signal transmitters 2 are electrically connected with light fixture sets 3A, 3B, and the like, respectively. That is, a lighting system 10B includes the light fixture sets 3A, 3B, and the like as the control object, and the signal transmitters 2 correspond one-to-one to the light fixture sets 3A, 3B and the like.

In the modified example, the one AC/DC converter 1 supplies DC power to the signal transmitters 2, and therefore the system configuration can be simplified in comparison with the case where the signal transmitters 2 are electrically connected one-to-one to AC/DC converters 1.

As stated above, a signal transmitter 2 according to a first aspect of the embodiment includes a power supply 21, an external signal receiver 221 and a communication controller 225. The power supply 21 is configured to receive DC power to supply a DC output voltage V2 to a light fixture(s) 3. The external signal receiver 221 is configured to receive an external instruction signal S1 that represents a lighting state of the light fixture 3 based on an output (signal) of a sensor (set) 5 configured to detect a state(s) of a lighting space A1 illuminated by the light fixture(s) 3. The communication controller 225 is configured to control signal transmission to the light fixture 3 by controlling the power supply 21. The communication controller 225 is configured to change an output voltage level of the power supply 21 to transmit, to the light fixture(s) 3, a transmission signal for setting the light fixture(s) 3 to the lighting state represented by at least the external instruction signal S1. As an example, the signal transmitter 2 may be configured to output the output voltage V2 to the light fixtures 3 and transmit the transmission signal to the light fixtures 3.

The signal transmitter 2 can therefore decrease transmission noise of the transmission signal and leakage of the transmission signal by changing the output voltage level to transmit the transmission signal in comparison with the case where a high frequency transmission signal is superposed on a DC voltage to be sent out. That is, the signal transmitter 2 can light the light fixture 3 by supplying DC power thereto and decrease the transmission noise of the transmission signal and the leakage of the transmission signal.

The signal transmitter 2 can change the output voltage V2, specifically the output voltage level of the power supply 21, thereby transmitting the transmission signal. The signal transmitter 2 can stabilize signal transmission and lengthen the transmission distance in comparison with the configuration in which a high frequency transmission signal is output with the transmission signal superposed on a DC voltage because it is possible to suppress the attenuation of the transmission signal, caused by the inductance of the two power supply lines E21 and E22.

In the first aspect, it is preferable that the transmission signal contain identification data uniquely assigned to the light fixture 3, and control data representing the lighting state to be instructed to the light fixture 3 (hereinafter referred to as a “second aspect”).

The signal transmitter 2 can therefore perform individual control and group control of light fixtures 3.

In a first or second aspect, the power supply 21 includes two input terminals 21A and 21B, a series circuit of a first switch Q1 and a second switch Q2, a first diode D1, a second diode D2, a series circuit of a capacitor C2 and an inductor L1, and two output terminals 21C and 21D. The two input terminals 21A and 21B are configured to receive the DC power. The series circuit of the first and second switches Q1 and Q2 is electrically connected between the two input terminals 21A and 21B. The first diode D1 is anti-parallel connected to the first switch Q1. The second diode D2 is anti-parallel connected to the second switch Q2. The series circuit of the capacitor C2 and the inductor L1 is connected between both ends of the first switch Q1. The output terminals 21C and 21D are electrically connected to high and low potential sides of the capacitor C2, respectively. The two output terminals 21C and 21D are configured to output the DC output voltage V2. The communication controller 225 is configured to control the first and second switches Q1 and Q2 to change the output voltage level. Hereinafter, the configuration is referred to as a “third aspect”.

The signal transmitter 2 can therefore transmit the transmission signal through the comparative simple configuration (circuit configuration). For example, the signal transmitter 2 can comparatively decrease the number of switches constituting the transmitter and a conduction loss of the switches. That is, the signal transmitter 2 can reduce the transmission loss.

In any one of the first to third aspects, it is preferable that the signal transmitter 2 further include an internal signal receiver 222 and a signal selector 223. The internal signal receiver 222 is configured to receive an internal instruction signal S2 that is generated according to user's operation and that represents the lighting state of the light fixture 3. The signal selector 223 is configured to select either the external instruction signal S1 or the internal instruction signal S2 to be supplied to the communication controller 225. The communication controller 225 is configured to transmit the transmission signal for setting the light fixture 3 to a lighting state represented by either the external instruction signal S1 or the internal instruction signal S2, from the signal selector 223. Hereinafter, the configuration is referred to as a “fourth aspect”.

The signal transmitter 2 can therefore select any of: the external instruction signal S1 based on the output of the sensor 5 configured to detect the state of the lighting space A1; and the internal instruction signal S2 based on the user's operation. As a result, the signal transmitter 2 can switch between automatic control based on the output of the sensor 5 and manual control by the user's operation.

In the fourth aspect, preferably the signal selector 223 is configured to select either the external instruction signal S1 or the internal instruction signal S2 according to the state of the lighting space A1 (hereinafter, referred to as a “fifth aspect”).

The signal transmitter 2 can therefore switch between the automatic control based on the output of the sensor 5 and the manual control based on the user's operation, in accordance with the state of the lighting space A1.

In the fifth aspect, preferably the signal selector 223 is configured to: select the external instruction signal S1 when the state of the lighting space A1 is in a normal state; and select the internal instruction signal S2 when the state of the lighting space A1 is in an abnormal state (hereinafter, referred to as a “sixth aspect”).

It is possible to improve safety when the lighting space A1 is in the abnormal state because the signal transmitter 2 prioritizes an operational instruction of the remote control device 6 and the operation unit 24 in the lighting space A1 in order to prioritize the person's safety in the lighting space A1 when the lighting space A1 is in the abnormal state.

In any one of the first to sixth aspects, preferably the signal transmitter 2 further includes a judgement controller 224. The judgement controller 224 is configured to monitor any one or more of an output current Ia, the output voltage V2, output power, an input current, an input voltage V1 and input power of the power supply 21 as a monitor value and judge whether the monitor value is greater than or equal to a prescribed value. The communication controller 225 is configured to transmit the transmission signal for changing a dimming rate of the light fixture 3 so that the monitor value is smaller than the prescribed value, when the judgement controller 224 judges that the monitor value is greater than or equal to the prescribed value. Hereinafter, the configuration is referred to as a “seventh aspect”.

When the number of light fixtures 3 exceeds the connection allowable number N, the signal transmitter 2 can therefore suppress the occurrence of failure caused by overload by decreasing the light output of the light source 33 per light fixture 3 to light respective light sources 33 of all the light fixtures 3.

In the seventh aspect, the communication controller 225 is configured to, when the judgement controller 224 judges that the monitor value is greater than or equal to the prescribed value, change the dimming rate of the light fixture 3 to a first dimming rate M1 so that the monitor value is less than the prescribed value. Preferably, the communication controller 225 then transmits the transmission signal for changing the dimming rate by repeatedly alternating between the first dimming rate M1 and a second dimming rate M2 that is lower than the dimming rate when the monitor value is equal to the prescribed value. Hereinafter, the configuration is referred to as an “eighth aspect”.

The signal transmitter 2 can therefore notify persons of overload by transmitting the transmission signal for changing the dimming rate so that the first dimming rate M1 and the second dimming rate M2 are alternately repeated, when the monitor value is greater than or equal to the prescribed value.

In the eighth aspect, preferably the communication controller 225 is configured to, when the judgement controller 224 judges that the monitor value is greater than or equal to the prescribed value, make the first dimming rate lower as a difference between the monitor value and the prescribed value is greater (hereinafter, referred to as a “ninth aspect”).

The signal transmitter 2 can therefore further suppress the occurrence of failure caused by overload when the connection number of light fixtures 3 exceeds the connection allowable number N.

In an eighth or ninth aspect, preferably the communication controller 225 is configured to, when the judgement controller 224 judges that the monitor value is greater than or equal to the prescribed value, make a period of time during which the dimming rate is the second dimming rate M2 longer as a difference between the monitor value and the prescribed value is greater (hereinafter, referred to as a “tenth aspect”).

The signal transmitter 2 can comparatively lengthen a period of time during which the light source 33 is dimmed with the light output thereof decreased, and therefore facilitates the recognition of a change in light output of the light source 33 by the person such as the contractor.

In any one of the seventh to tenth aspects, the communication controller 225 is configured to transmit the transmission signal for changing the dimming rate and a color temperature of the light fixture 3. Preferably, the communication controller 225 is configured to change only the dimming rate so that the monitor value is less than the prescribed value, when the judgement controller 224 judges that the monitor value is greater than or equal to the prescribed value. Hereinafter, the configuration is referred to as an “eleventh aspect”.

The signal transmitter 2 facilitates the recognition of a change in light output of the light source 33 by a person such as contractor by changing only the dimming rate in comparison with the case where both the dimming rate and the color temperature are changed.

In any one of the first to eleventh aspects, the communication controller 225 is configured to change the output voltage level between a first voltage level V21 and a second voltage level V22 to transmit the transmission signal. Hereinafter, the configuration is referred to as a “twelfth aspect”.

In any one of the first to twelfth aspects, the lighting state represents at least one of a color temperature and a dimming amount (dimming rate) of the lighting fixture 3. Hereinafter, the configuration is referred to as a “thirteenth aspect”.

A signal transmitter 2 according to a fourteenth aspect of the embodiment includes a power supply 21, an external signal receiver 221 and a communication controller 225. The power supply 21 is configured to receive DC power to supply a DC output voltage V2 to a light fixture 3. The external signal receiver 221 is configured to receive an external instruction signal S1 that represents a lighting state of the light fixture 3 based on an output of a sensor 5 configured to detect a state of a lighting space A1 illuminated by the light fixture 3. The communication controller 225 is configured to transmit, to the light fixture 3, a transmission signal for setting the light fixture 3 to the lighting state represented by at least the external instruction signal S1.

The signal transmitter 2 can decrease transmission noise of the transmission signal and leakage of the transmission signal.

In the fourteenth aspect, the communication controller 225 controls the power supply 21 to change the DC output voltage V2 of the power supply 21 to transmit the transmission signal. The DC output voltage V2 is for providing operating current to a light source 33 included in the light fixture 3. Hereinafter, the configuration is referred to as a “fifteenth aspect”.

In a fourteenth or fifteenth aspect, a signal transmitter 2 includes at least one of a signal cable through which the communication controller 225 transmits the transmission signal to the light fixture 3, or a wireless communication interface through which the communication controller 225 transmits the transmission signal to the light fixture 3 wirelessly. Hereinafter, the configuration is referred to as a “sixteenth aspect”.

In any one of the first to sixteenth aspects, the communication controller 225 is configured to: adjust the output voltage level to a first voltage level V21 by making a detection result of the DC output voltage V2 accord with a voltage of a first target value; and adjust the output voltage level to a second voltage level V22 by making the detection result of the DC output voltage V2 accord with a voltage of a second target value. Hereinafter, the configuration is referred to as a “seventeenth aspect”. In an example, the signal transmitter 2 includes a voltage detector circuit configured to detect the output voltage V2 to obtain the detection result. In another example, the communication controller 225 is provided with the detection result from an electric conductor for detecting the output voltage V2 to provide the communication controller 225 with the detection result, which is electrically connected between the positive output terminal of the power supply 21 and the communication controller 225.

Thus, the communication controller 225 adjusts the output voltage level to the first and second voltage levels V21 and V22 and can thereby change the output voltage level to transmit the transmission signal to the light fixture 3. The communication controller 225 can therefore decrease transmission noise of the transmission signal and leakage of the transmission signal.

A lighting system 10, 10A or 10B according to an eighteenth aspect of the embodiment includes a signal transmitter 2 of any one of the first to seventeenth aspects, an AC/DC converter 1 configured to receive AC power to supply the DC power to the signal transmitter 2, and the light fixture 3.

By including the signal transmitter 2, a lighting system 10, 10A or 10B can light the light fixture 3 by supplying DC power thereto and decrease the transmission noise and the leakage of the transmission signal.

A lighting system 10B according to a nineteenth aspect of the embodiment includes signal transmitters 2, one AC/DC converter 1 and light fixture sets 3A, 3B and the like. The AC/DC converter 1 is configured to receive AC power to supply DC power to each of the signal transmitters 2.

The light fixture sets 3A, 3B and the like are electrically connected to the signal transmitters 2, respectively. Each of the light fixture sets 3A, 3B and the like includes at least a light fixture 3. Each of the signal transmitters 2 includes a power supply 21, an external signal receiver 221 and a communication controller 225. The power supply 21 is configured to receive the DC power to supply a DC output voltage V2 to a corresponding light fixture set. The external signal receiver 221 is configured to receive an external instruction signal S1 that represents a lighting state of the corresponding light fixture set based on an output of a sensor 5 configured to detect a state of a lighting space A1 illuminated by the corresponding light fixture set. The communication controller 225 is configured to control signal transmission to the corresponding light fixture set by controlling the power supply 21. The communication controller 225 is configured to change an output voltage level of the power supply 21 to transmit, to the corresponding light fixture set, a transmission signal for setting the corresponding light fixture set to the lighting state represented by at least the external instruction signal 51. As an example, each signal transmitter 2 may be configured to supply the output voltage V2 to its own light fixtures 3 and transmit the transmission signal to the light fixtures 3.

The system configuration of the lighting system 10B can be simplified in comparison with the case where the signal transmitters 2 are electrically connected one-to-one to AC/DC converters 1.

In the nineteenth aspect, the transmission signal contains identification data uniquely assigned to the light fixture 3, and control data representing the lighting state for the light fixture 3. Hereinafter, the configuration is referred to as a “twentieth aspect”.

A light fixture 3 according to a twenty-first aspect of the embodiment includes a light source 33, a constant current circuit 32 and a signal receiver 31. The constant current circuit 32 is configured to receive a DC output voltage V2 to supply a load current to the light source 33. The DC output voltage V2 is input via two power supply lines E21 and E22 from the abovementioned signal transmitter 2 of the first aspect. The signal receiver 31 is configured to monitor the DC output voltage V2. The signal receiver 31 is configured to detect a change in the output voltage level to acquire a transmission signal and adjust a lighting state of the light fixture 33 by controlling the constant current circuit 32 based on data of the transmission signal.

The light fixture 3 receives the DC voltage V2 from the signal transmitter 2, and can therefore light the light source 33 by the DC power and decrease transmission noise and leakage of the transmission signal.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A signal transmitter, comprising:
a power supply configured to receive DC power to supply a DC output voltage to a light fixture;
an external signal receiver configured to receive an external instruction signal that represents a lighting state of the light fixture based on an output of a sensor configured to detect a state of a lighting space illuminated by the light fixture; and
a communication controller configured to control signal transmission to the light fixture by controlling the power supply, the communication controller being configured to change an output voltage level of the power supply to transmit, to the light fixture, a transmission signal for setting the light fixture to the lighting state represented by at least the external instruction signal.

2. The signal transmitter of claim 1, wherein the transmission signal contains identification data uniquely assigned to the light fixture, and control data representing the lighting state for the light fixture.

3. A signal transmitter of claim 1, wherein
the power supply comprises:
two input terminals for receiving the DC power;
a series circuit of a first switch and a second switch, the series circuit being electrically connected between the two input terminals;
a first diode that is anti-parallel connected to the first switch;
a second diode that is anti-parallel connected to the second switch;
a series circuit of a capacitor and an inductor, which is connected between both ends of the first switch; and
two output terminals for outputting the DC output voltage, the output terminals being electrically connected to high and low potential sides of the capacitor, respectively and
the communication controller is configured to control the first and second switches to change the output voltage level.

4. A signal transmitter of claim 1, further comprising:
an internal signal receiver configured to receive an internal instruction signal that represents the lighting state of the light fixture, the internal instruction signal being generated according to user's operation; and
a signal selector configured to select either the external instruction signal or the internal instruction signal to be supplied to the communication controller, wherein
the communication controller is configured to transmit the transmission signal for setting the light fixture to a lighting state represented by either the external instruction signal or the internal instruction signal, from the signal selector.

5. The signal transmitter of claim 4, wherein the signal selector is configured to select either the external instruction signal or the internal instruction signal according to the state of the lighting space.

6. The signal transmitter of claim 5, wherein the signal selector is configured to:
select the external instruction signal when the state of the lighting space is in a normal state; and
select the internal instruction signal when the state of the lighting space is in an abnormal state.

7. A signal transmitter of claim 1, further comprising a judgement controller configured to monitor a value of any one or more of an output current, the output voltage, output power, an input current, an input voltage and input power of the power supply as a monitor value and judge whether the monitor value is greater than or equal to a prescribed value, wherein
the communication controller is configured to transmit the transmission signal for changing a dimming rate of the light fixture so that the monitor value is smaller than the prescribed value, when the judgement controller judges that the monitor value is greater than or equal to the prescribed value.

8. The signal transmitter of claim 7, wherein the communication controller is configured to, when the judgement controller judges that the monitor value is greater than or equal to the prescribed value,
change the dimming rate of the light fixture to a first dimming rate so that the monitor value is less than the prescribed value, and then
transmit the transmission signal for changing the dimming rate by repeatedly alternating between the first dimming rate and a second dimming rate that is lower than the dimming rate when the monitor value is equal to the prescribed value.

9. The signal transmitter of claim 8, wherein the communication controller is configured to, when the judgement controller judges that the monitor value is greater than or equal to the prescribed value, make the first dimming rate lower as a difference between the monitor value and the prescribed value is greater.

10. A signal transmitter of claim 8, wherein the communication controller is configured to, when the judgement controller judges that the monitor value is greater than or equal to the prescribed value, make a period of time during which the dimming rate is the second dimming rate longer as a difference between the monitor value and the prescribed value is greater.

11. A signal transmitter of claim 7, wherein the communication controller is configured to transmit the transmission signal for changing of the dimming rate and a color temperature of the light fixture, the communication controller being configured to change only the dimming rate so that the monitor value is less than the prescribed value, when the judgement controller judges that the monitor value is greater than or equal to the prescribed value.

12. A signal transmitter of claim 1, wherein the communication controller is configured to change the output voltage level between a first voltage level and a second voltage level to transmit the transmission signal.

13. A signal transmitter of claim 1, wherein the lighting state represents at least one of a color temperature and a dimming amount of the lighting fixture.

14. A signal transmitter, comprising:
a power supply configured to receive DC power to supply a DC output voltage to a light fixture;
an external signal receiver configured to receive an external instruction signal that represents a lighting state of the light fixture based on an output of a sensor configured to detect a state of a lighting space illuminated by the light fixture; and
a communication controller configured to transmit, to the light fixture, a transmission signal for setting the light fixture to the lighting state represented by at least the external instruction signal.

15. The signal transmitter of claim 14, wherein the communication controller controls the power supply to change the DC output voltage of the power supply to transmit the transmission signal, the DC output voltage for providing operating current to a light source included in the light fixture.

16. A signal transmitter of claim 14, comprising at least one of a signal cable through which the communication controller transmits the transmission signal to the light fixture, or a wireless communication interface through which the communication controller transmits the transmission signal to the light fixture wirelessly.

17. A signal transmitter of claim 1, wherein the communication controller is configured to:
adjust the output voltage level to a first voltage level by making a detection value of the DC output voltage accord with a first target value; and
adjust the output voltage level to a second voltage level by making the detection value of the DC output voltage accord with a second target value.

18. A lighting system, comprising
a signal transmitter of claim 1,
an AC/DC converter configured to receive AC power to supply the DC power to the signal transmitter, and
the light fixture.

19. A lighting system, comprising
signal transmitters, one AC/DC converter configured to receive AC power to supply DC power to each of the signal transmitters, and light fixture sets that are electrically connected to the signal transmitters, respectively, each of the light fixture sets comprising at least a light fixture, wherein
each of the signal transmitters comprises:
a power supply configured to receive the DC power to supply a DC output voltage to a corresponding light fixture set;
an external signal receiver configured to receive an external instruction signal that represents a lighting state of the corresponding light fixture set based on an output of a sensor configured to detect a state of a lighting space illuminated by the corresponding light fixture set; and
a communication controller configured to control signal transmission to the corresponding light fixture set by controlling the power supply, the communication controller being configured to change an output voltage level of the power supply to transmit, to the corresponding light fixture set, a transmission signal for setting the corresponding light fixture set to the lighting state represented by at least the external instruction signal.

20. The lighting system of claim 19, wherein the transmission signal contains identification data uniquely assigned to the light fixture, and control data representing the lighting state for the light fixture.

21. A light fixture, comprising:
a light source;
a constant current circuit configured to receive a DC output voltage to supply a load current to the light source, the DC output voltage being input via two power supply lines from the signal transmitter of claim 1; and
a signal receiver configured to monitor the DC output voltage, the signal receiver being configured to detect a change in the output voltage level to acquire a transmission signal and adjust a lighting state of the light fixture by controlling the constant current circuit based on data of the transmission signal.
